(19) United States
(12) Patent Application Publication
(10) Pub. No.: US 2007/0030876 A1
(43) Pub. Date: Feb. 8, 2007

(54) Apparatus and method for purging and recharging excimer laser gases

(76) Inventor: Jeffrey I. Levatter, Solana Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/497,786

(22) Filed: Aug. 2, 2006

Related U.S. Application Data
(60) Provisional application No. 60/705,850, filed on Aug. 5, 2005.

(51) Int. Cl. H01S 3/22; H01S 3/223

(52) U.S. Cl. 372/57; 372/59; 372/58

(57) ABSTRACT

A method of recharging an excimer laser Includes opening an outlet in a chamber containing spent laser gas at a first pressure, opening an inlet in the chamber, the inlet in communication with a laser gas container at a second pressure higher than the first pressure, and flowing fresh laser gas into the chamber and removing at least a portion of the spent laser gases from the chamber without using a vacuum pump.

### CROSS-REFERENCE TO RELATED APPLICATIONS

This application claims priority under 35 U.S.C. §119(e) to U.S. Provisional Application Ser. No. 60/705,850, filed Aug. 5, 2005, entitled “Excimer Laser Gas Exchange Process,” which is incorporated herein by reference in its entirety.

### BACKGROUND

1. Field

The present invention relates to rare gas-halogen excimer lasers and, in particular, to increasing the operational lifetime, reliability, efficiency, and/or performance of such lasers.

2. Description of the Related Art

An excimer laser uses a rare gas such as krypton (Kr), xenon (Xe), argon (Ar), or neon (Ne), and a halide gas or a gas containing a halide, for example fluorine (F₂) or hydrogen chloride (HCl), as the active components. These active components and possibly other gases are contained in a pressure vessel provided with longitudinally extending lasing electrodes for inducing a transverse electrical discharge in the gases. The discharge causes the formation of excited rare gas-halide molecules whose disassociation results in the emission of ultraviolet photons constituting the laser light. In many excimer lasers, xenon chloride (XeCl) is the rare gas-halogen used for generating light at a wavelength, e.g., of about 308 nanometers. The laser further comprises mirrors or reflective surfaces that form an optical cavity to establish an optical resonance condition. Such a system is also described in U.S. patent application Ser. No. 10/776,463, filed Feb. 11, 2004, entitled “Rare Gas-Halogen Excimer Laser with Baffles,” which is incorporated herein by reference in its entirety. The chamber may include inlet and outlet ports for flow of gases into and out of the chamber.

With continued operation of the laser, halide gas is depleted, diminishing the output of the laser. In addition, over time gases that interfere with proper laser action may accumulate in the laser. To regain performance, these deleterious gases are removed from the laser and additional laser gases are replenished. What is needed are improved methods for performing this revitalization process.

### SUMMARY

In certain embodiments, a method of recharging an excimer laser comprises opening an outlet in a chamber containing spent laser gas at a first pressure, opening an inlet in the chamber, the inlet in communication with a laser gas container at a second pressure higher than the first pressure, and flowing fresh laser gas into the chamber and removing at least a portion of the spent laser gases from the chamber without using a vacuum pump.

In certain embodiments, a method of recharging an excimer laser comprises opening an outlet in a chamber containing a first gas at a first pressure, opening an inlet in the chamber, the inlet in communication with a container containing a second gas at a second pressure higher than the first pressure of the first gas in the chamber, and flowing the second gas from the container into the chamber and removing the majority of the first gases from the chamber without using a vacuum pump.

In certain embodiments, a method of recharging an excimer laser comprises opening an outlet in a chamber containing spent laser gas at a first pressure, opening an inlet in the chamber, the inlet in communication with a laser gas container at a second pressure higher than the first pressure, and flowing fresh laser gas into the chamber and removing at least a portion of the spent laser gases from the chamber with both the inlet and outlet open.

In certain embodiments an apparatus for recharging an excimer laser comprises a first valve for opening and closing an outlet in a laser chamber containing spent laser gas at a first pressure, a second valve for an inlet in the chamber, the inlet in fluid communication with a laser gas container at a second pressure higher than the first pressure, and a controller in communication with the first and second valves. The controller is configured to open the first and second valves such that at least a portion of the spent laser gas is removed and fresh laser gas from the laser gas container is introduced without using a vacuum pump.

### BRIEF DESCRIPTION OF THE DRAWINGS

FIG. 1 is a schematic, lengthwise cross-sectional view of an embodiment of an excimer laser.

FIG. 2 is a block diagram of an embodiment of a method for recharging laser gases.

FIG. 3 is a block diagram of another embodiment of a method for recharging laser gases.

FIG. 4 is a block diagram of an embodiment of an excimer laser that includes a controller for controlling a gas exchange process.

### DETAILED DESCRIPTION OF THE PREFERRED EMBODIMENTS

Excimer lasers can emit pulses of ultraviolet radiation and have potentially many practical applications in medicine, industry, and communications. This potential success has remained to a large extent unfulfilled because of numerous problems that limit the period of time during which excimer lasers will operate without requiring substantial maintenance or experiencing performance difficulties. One of the obstacles to achieving a practical excimer laser is that contamination of the laser gases or the optics in the pressure vessel necessitates frequent major maintenance and/or disassembly of the laser such as, for example, in the case where the windows need to be replaced.

Some portion of the halogens (e.g., Cl) will permanently dissociate from the noble gas (e.g., Xe) and re-associate with another charged molecule (or “ion”) besides the noble gas. Such ions may be from other constituent elements found in the gas mixture or, more typically, will be from atoms that have broken away from the materials comprising the internal surfaces of the chamber or from the components within the chamber. Often, this new association is manifested by small solid particulates that may deposit on the internal surfaces of the chamber and the components therein. The halogen may also associate directly with a molecule that did not break away, but that remained bound to one of the internal surfaces of the chamber or of a component found in the chamber.

The byproduct resulting from the new association of a halogen and an ion may be stable or unstable depending on the materials used for chamber construction. An unstable byproduct resulting from the association of a halogen with another ion or molecule typically has a high vapor pressure. As such, these byproducts are more apt to be more numerous in gaseous form, resulting in more collisions on the surface of the laser chamber. Thus, these unstable molecular compounds are usually deleterious and are therefore considered contaminants. Some species of such compounds will absorb the desired laser energy or interfere with the gas kinetics (e.g., inhibit the formation of the excited molecules that emit photons at the laser wavelength). Carbon is one of the most pernicious of such elements that reacts with halogens. An example of a molecular species comprising carbon and a halogen that is optically absorbing is carbon tetrachloride (CCl₄). Such materials or compounds can be very deleterious to the performance of laser action, so hydrocarbons are preferably not included in the chamber.

Where the byproduct is stable, the byproduct is slow to form, and, once formed, the byproduct is slow to de-form. For example, nickel (Ni) is a preferred material for the internal surfaces of a laser chamber and the external surfaces of components therein, insofar as nickel is slow to react with certain halides to form stable byproducts. Once associated with a halogen, the nickel is slow to dissociate from the halogen. Alumina (Al₂O₃) is another preferred material that may be used to fabricate the internal surfaces of a laser chamber and the external surfaces of components therein. Selection of materials that do not produce unstable byproducts when exposed to halogen gas is discussed in U.S. Pat. No. 4,891,818, filed Mar. 13, 1989, issued Jan. 2, 1990, entitled “Rare Gas-Halogen Excimer Laser,” which is incorporated herein by reference in its entirety.

Accordingly, excimer laser chamber construction is such that the laser gases deteriorate by two main processes. First, the laser halogen gas species is consumed by allowing the halogen to react with the various materials of the laser chamber. Second, formation of non-desirable and optically absorbing halogen molecular species (e.g., CCl₄) inhibits optical output.

In an excimer laser chamber constructed from materials (e.g., Ni and alumina) that do not readily react with halogen gas to produce unstable high vapor pressure products, the dominant mechanism of gas deterioration is the loss of the halogen species by slow chemical reaction to form stable or low vapor pressure byproducts. Such interaction is ineluctable, but where the loss is due to stable byproducts, the process is gradual and acceptable. A chamber that reacts slowly with the gas medium to yield stable, non-contaminating byproducts, however, can consume the available supply of halogen molecules. At a certain point, therefore, recharging the chamber with a fresh dose of the gas mixture becomes advisable.

A chamber that interacts with the gas medium to yield sufficient quantities of unstable (high vapor pressure) byproducts will typically lose its ability to efficiently produce laser output many times more rapidly than a chamber that interacts to form stable (low vapor pressure) byproducts. In addition to depleting the laser gases, contaminating gases can be produced in the chamber. Such gases can mix with the laser gases within the chamber, absorb light and electrons, and otherwise interfere with laser action, thereby causing laser output to diminish. To restore effectiveness to the chamber, the chamber is typically recharged with a fresh fill of laser gas. In addition to injecting a fresh charge of halogen containing gas, the gaseous byproducts are usually purged from the chamber because leaving such byproducts in the chamber invites the rapid loss of effectiveness of the fresh charge of laser gas.

Thus, in a typical excimer laser chamber designed with less than optimum materials, in addition to replacing the consumed halogen, the non-desirable, contaminating, and optically absorbing halogen compounds are typically removed, for example, with a vacuum pump having a capacity sufficient to remove substantially all the gases. The spent gas mixture is purged from the chamber through an outlet port, for example by being extracted by a vacuum pump while an inlet port remains shut. To suitably purge the chamber of unstable byproducts, reasonable vacuum levels are used. The pressure in the chamber may be reduced, for example, to between about a few Torr and 10⁻⁶ Torr by the vacuum pump. It will be appreciated that the chamber is sealed so as to allow such pressures within the chamber. Once the chamber has been suitably purged, the outlet port is shut and a fresh charge of laser gas is introduced via the inlet port. A single input/output port may be used to both evacuate the charge and to introduce fresh laser gases into the chamber. For example, the vacuum pump can be disconnected from the single port and a source of laser gases can be connected to the single port. One or more valves may be used to switch between the vacuum pump to the source of lasers gases.

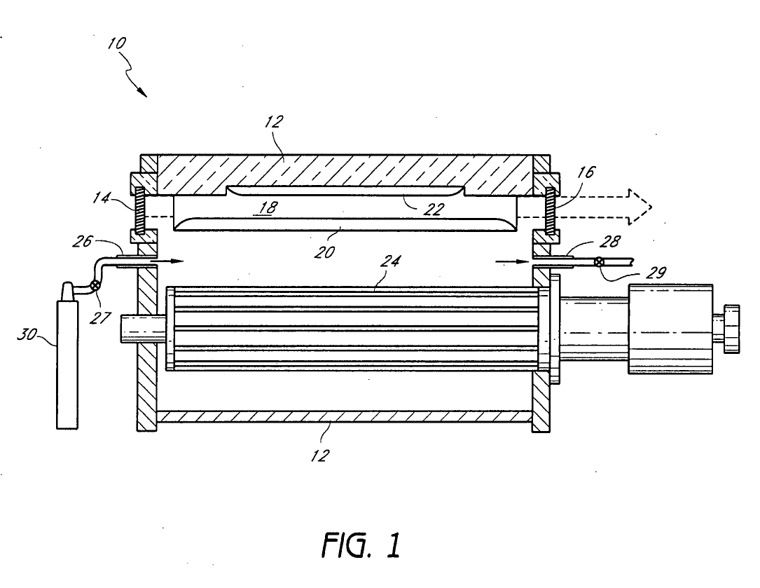

FIG. 1 illustrates a cross-sectional view of an example laser 10 capable of performing an alternative gas exchange processes that is described herein. In this alternative gas exchange process, no vacuum pump is required.

The laser 10 shown in FIG. 1 comprises a chamber 12 for containing laser gases. Lasing electrodes 20, 22 longitudinally extending within the chamber 12 are configured to induce a transverse electrical discharge in laser gases within the chamber 12. The electrical discharge causes the formation of excited rare gas-halide molecules, whose disassociation results in the emission of ultraviolet photons constituting the laser light. The lasers 102, 104 further comprise optical elements 14, 16 (e.g., partially reflective elements, mirrors, etc.) that form an optical cavity 18 to establish an optical resonance condition. Laser gases within the chamber 12 are circulated between the lasing electrodes 20, 22 by a fan 24. The laser gases may be cooled by a heat exchanger, i.e., a structure that removes excess heat, and the like.

The laser 10 further includes inlet 26 and outlet 28 through the chamber 12. The inlet 26 is in communication with a gas source 30 via valve 27. In certain embodiments, the laser 10 further comprises a regulator disposed between the gas source 30 and the inlet 26 so as to avoid exposing the inlet 26 to the full pressure within the gas source 30. The gas source 30 may be a pressurized cylinder, a holding canister, and the like. The gas source 30 preferably contains laser gases (e.g., a noble gas and a halogen), and more preferably contains gases comprising xenon and chlorine. In various embodiments, the gas source 30 has a gas pressure of at least several times greater than the fill pressure of the chamber 12. In some embodiments, excimer lasers are operated at pressures between about 1 atmosphere (atm) to several atmospheres (e.g., between about 1 and 3 atm), so the gas source 30 in certain embodiments is at, for example, a pressure greater than 100 pounds per square inch gauge (psig). In a preferred embodiment, the laser 10 has a gas pressure of between about 1.2 and 1.3 atm, e,g., about 1.22 atm. In such embodiments, the gas source 30 preferably has a gas pressure output (e.g., internal or regulated) of between about 3.4 and 3.5 atm, e.g., about 3.45 atm. In certain embodiments, the gas pressure in the laser 10 does not exceed about 40 psig.

In certain embodiments, the outlet 28 is in not in fluid communication with any type of vacuum pump, although the valve 29 may control communication between the outlet 28 and an exhaust, a scrubber, a containment canister, etc. It will be appreciated that vacuumless operation of the laser 10 includes embodiments in which a vacuum pump may be included elsewhere in the system for purposes other than recharging or purging of the laser 10.

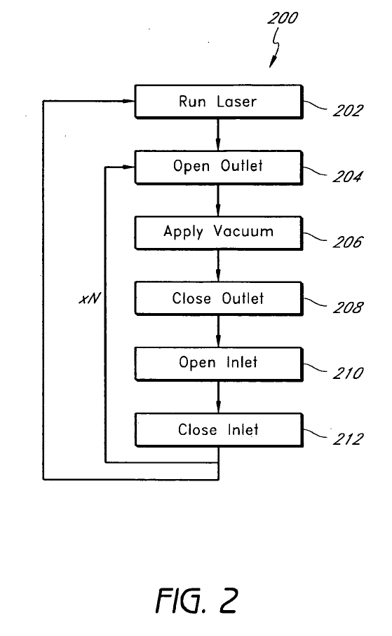

FIG. 2 is a block diagram of an embodiment of a method 200 of recharging laser gases, which is typically performed on chambers not comprising preferred materials. In block 202, the laser is run, for example until the halogen is sufficiently consumed or until a buildup of contaminants (e.g., CCl₄) renders operation inefficient. In block 204, an outlet of the chamber is opened so as to allow evacuation of spent laser gas from the chamber. In block 206, a vacuum in communication with the outlet port extracts the gas from within the chamber. In block 208, the outlet is closed once the chamber has reached a sufficient vacuum level. In embodiments with a single port through the chamber, the vacuum may be disconnected from the outlet and a laser gas source may be connected, transforming the outlet into an inlet. After block 206, the chamber is usually at a pressure less than the pressure of the laser gas source. In block 210, the inlet is opened so as to allow a new charge of laser gas to flow into the chamber due to the pressure gradient between the chamber and the laser gas source. Once the chamber reaches a desired pressure, the inlet is closed, as shown in block 212. With the fresh charge of laser gas and the contaminants evacuated, the laser is ready to be run again, for example by returning to block 202.

The evacuation may be repeated after the fresh charge of laser gas has been introduced, for example by returning to block 204. In such an embodiment, the vacuum may be used to evacuate both the fresh charge of laser gas and any lingering contaminated gas. Accordingly, the fresh charge of laser gas is pumped out along with the diluted residual unstable byproducts. Introduction of fresh laser gas is then repeated. The process may be iterated N times until the gas in the chamber is sufficiently free of contaminants to permit efficient operation of the laser.

Referring again to FIG. 1, the example laser 10 is capable of performing a vacuumless gas exchange processes described herein when the chamber 12 comprises primarily “stable” materials, which allows the elimination of a vacuum pump from the laser 10. Inclusion of a vacuum pump generally increases the cost of the laser, and, likewise, elimination of the vacuum pump can result in substantially reduced costs. Reduced size may also be an advantage. Compactness is especially desired for equipment located in a health care provider's office, where space may be limited. In addition, removal of the vacuum pump may simplify the process of revitalizing or refurbishing the laser described below, thereby saving time, man-hours, and overall servicing cost.

In embodiments in which the chamber 12 comprises stable materials, there is a paucity of unstable byproducts in the chamber 12, thereby mitigating or eliminating the need for a vacuum pump. The stable materials can also extend the life of the laser 10 by reducing degradation of chamber 12 and components therein. Such a chamber has surfaces, whether internal surfaces of the chamber 12 itself or external surfaces of components within the chamber 12 (e.g., the fan 24), comprising materials that are slow to react (and to form gaseous byproducts) in the energized environment of an excimer chamber 12. Stable materials are such that their byproducts are also slow to react with the active medium (e.g., the halogens in the laser gas) in the chamber 12 and to form contaminants. Stable materials and their expected byproducts in the chamber 12 are stable in physical state and in chemical state vis-à-vis the active medium. In general, such material and such stable byproducts preferably have relatively low vapor pressures (e.g., between about 10⁻⁴ and 10⁻⁶ Torr) at normal operating temperatures. Accordingly, contaminating materials are preferably excluded from the chamber 12.

Certain embodiments thus comprise an excimer laser 10 with a sufficiently clean chamber 12, wherein fill gas in the chamber 12, having been spent from use, as well as other gases in the chamber, may be replaced without the aid of a vacuum pump and may be substituted and replenished with fresh gas that is injected into the chamber 12 under pressures normally encountered in containers 30 of such replenishing gas. As used herein, the word “spent” is to be given its broadest possible interpretation including, but not limited to, laser gas that has been depleted (e.g., partially depleted, fully depleted). Replenishing spent laser gas may be performed after the laser has produced a given quantity of laser pulses (e.g., between about 100,000 and 100,000,000), after the laser has been used (e.g., producing laser output) for a certain period of time or laser gas that has been in the chamber for a certain period of time, etc.

With a properly constructed excimer laser chamber 12, gas exchange in the laser 10 may be implemented by replacing the slowly consumed halogen gas without needing to evacuate the chamber, for example because little if any contaminants are formed. This gas exchange or replacement process can be completed by flushing the laser chamber 12 with high pressure laser gas and expelling the spent gas, as described in detail below. This mechanism of laser gas exchange greatly simplifies the typical gas exchange process by eliminating the need for a vacuum pump.

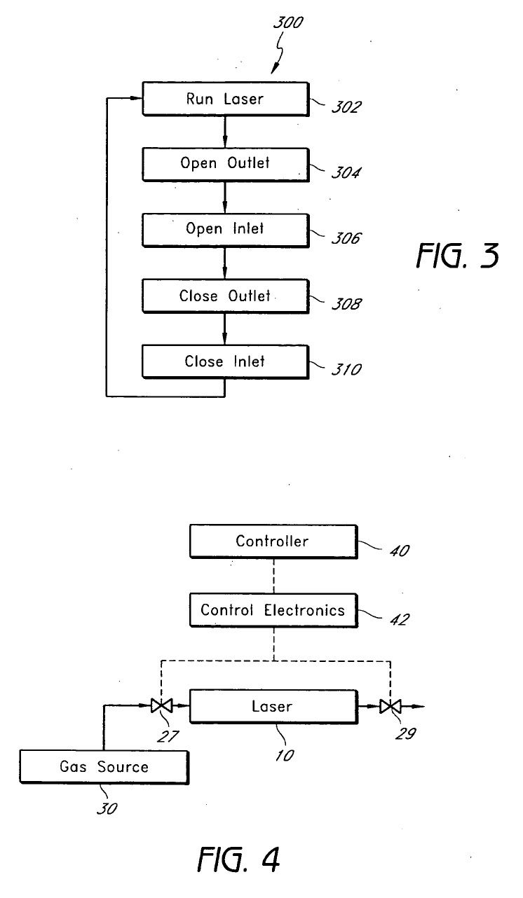

FIG. 3 is a block diagram of an embodiment of a method 300 of recharging laser gases, for example performed on chambers comprising stable materials. In block 302, the laser is run, for example until the halogen is spent (e.g., depleted, for a certain number of laser pulses, operated or producing laser pulses for a certain period of time, etc. as described above). In block 304, an outlet of the chamber is opened, for example to allow the spent laser gas to flow out of the chamber if the chamber is at a higher pressure than an ambient pressure around the chamber. In block 306, the inlet is opened so as to allow fresh laser gas to flow into the chamber due to the pressure gradient between the chamber and the laser gas source. Alternatively, the inlet can be opened prior to, or at the same time as, the outlet is opened. As a fresh charge of laser gas is injected under pressure from the gas source into the chamber through the inlet, the spent gas is ejected from the chamber through the outlet, for example to an exhaust. The pressure in the chamber may be monitored while both the inlet and outlet are opened, for example to check for clogged lines and for safety reasons.

In some embodiments, some of the fresh laser gas with a higher content of halide molecules is purged from the chamber along with the spent gas. In addition, some of the spent gas is mingled with the fresh gas and stays in the chamber. Thus, there may be some inefficiency due to such loss and dilution. Such inefficiency is trivial in comparison to the quantity of fresh gas that is lost due to the multiple evacuations and fills used for chambers comprising unstable materials described above. For example, a number N of iterative evacuations would require filling the chamber with laser gas N times. However, in some embodiments, the vacuumless process may be repeated, for example, for three times, to ensure complete gas exchange. In some embodiments, the fan 24 is run during certain portions of the method 300, for example to mix the spent and fresh laser gases.

After a certain purge time or after a certain halogen concentration has been achieved in the chamber, the outlet is closed, as shown in block 308. Because the inlet remains open, the chamber fills with fresh laser gas. Parameters such as pressure in the chamber and duration may be monitored during the filling process, for example to check for leaks and for safety reasons. The inlet is then closed, as shown in block 310. The time between blocks 308 and 310 can be determined by the desired pressure in the chamber. For example, immediately closing the inlet may result in a pressure closer to the ambient pressure around the laser while a delay may result in a pressure closer to the pressure of the gas source. It will be understood that such timing may be affected by the size of the inlet, the pressure of the gas source, and the like. With the fresh charge of laser gas and the spent gas substantially removed, the laser is ready to be run again, for example by returning to block 302. If the pressure in the chamber is too low, the inlet may be opened to “top off” the chamber. If the pressure in the chamber is too high, the outlet may be opened to “vent” the chamber. Venting and topping off may also be performed when the pressure in the chamber is low or high between recharge cycles. In certain embodiments, some time is allowed to elapse between filling and laser operation in order for the pressure in the chamber to equilibrate.

The method 300 may similarly be used to charge a chamber filled with an inert gas (e.g., nitrogen, neon) with laser gases. A chamber may be filled with inert gases during shipment, installation, maintenance, and the like. After such procedures, the chamber is filled with laser gases in order to operate the laser. In embodiments where laser gases replace inert gas, the purge time may be increased versus embodiments in which the chamber was filled with spent laser gas.

The process may be manually performed by a user such as a service provider who provides maintenance and repair for the laser. Such a user may open and close the valves in a manner such as shown in the flow diagram of FIG. 3 to flow fresh laser gases into the chamber and to remove spent gases. The process may also be fully or partially automated.

FIG. 4 shows a laser system configured to automatically perform the gas exchange process. As illustrated in FIG. 4, a controller 40 is in communication with control electronics 42. The control electronics are in communication (e.g., electrical, mechanical, optical, hydraulic, etc.) with the valves 27, 29, and are configured to open and close the valves 27, 29 in response to a signal from the controller 40. When the control electronics 42 open the valve 27, gas may flow into the laser 10 from the gas source 30, which is in fluid communication with the valve 27 and the laser 10. When the control electronics 42 open the valve 29, gas may flow out of the laser 10. In certain embodiments, the controller 40 is programmed to open and close the valves 27, 29 such that at least a portion of spent laser gas is removed and fresh laser gas from the laser gas source 30 is introduced to the laser 10 without using a vacuum pump. The laser system may further include timers, light sensors, chemical sensors, pressure sensors, or other types of sensors (not shown) that can be used to trigger an exchange process. For example, light sensors may count pulses or the time that the laser 10 is on, chemical sensors may monitor halogen concentration, etc. In certain embodiments, the system is not fully automatic, but includes a user interface for control by a user. In such embodiments, a user of the system may be able to interface with the controller 40 at the laser 10, the gas source 30, or remotely.

Accordingly, the structure of the logic for various embodiments of the present invention as well as the logic for other designs may be embodied in computer program software. Moreover, those skilled in the art will appreciate that various structures of logic elements, such as computer program code elements or electronic logic circuits are illustrated herein. Manifestly, a variety of embodiments include a machine component that renders the logic elements in a form that instructs the valves 27, 29 or other apparatuses to perform, e.g., in a sequence of actions. The logic may be embodied by a computer program that is executed by the processor or electronics as a series of computer- or control element-executable instructions. These instructions or data usable to generate these instructions may reside, for example, in RAM, on a hard drive or optical drive, or on a disc. Alternatively, the instructions may be stored on magnetic tape, electronic read-only memory, or other appropriate data storage device or computer accessible medium that may or may not be dynamically changed or updated. Accordingly, these methods and processes including, but not limited to, those specifically recited herein may be included, for example, on magnetic discs, optical discs such as compact discs, optical disc drives or other storage devices or medium known in the art as well as those yet to be devised. The storage mediums may contain the processing steps which are implemented using hardware, for example, to control the valves 27, 29, the electrodes 20, 22, the fan 24, etc. These instructions may be in a format on the storage medium that is subsequently altered. For example, these instructions may be in a format that is data compressed.

The controller 40 and control electronics 42 depicted in FIG. 4 represent various non-limiting embodiments of the invention and the control of the valves 27, 29 can be implemented in other ways as well. For example, a user interface may be employed in alternative to, or in conjunction with, a fully or partially automatic controller 40. The user interface may comprise, for example, computer, laptop, palm top, personal digital assistant, cellphone, or the like. Information may be displayed on a screen, monitor, or other display, and/or conveyed to the user via, e.g., audio or tactilely, as well as visually. A keyboard or keypad, or one or more buttons, switches, and sensors can be used to input information such as commands, data, specification, settings, etc. A mouse, joystick, or other interfaces can be used as well. User interfaces both well known in the art, as well as those yet to be devised may be employed to input and output information and commands.

In addition, some or all of the control electronics may be included in the controller 40 or user interface. For example, in the case where the user interface comprises a computer, laptop, palm top, personal digital assistant, cellphone, or the like, both the interface as well as some or all of the control and processing electronics may be included in the computer, laptop, palm top, personal digital assistant, cellphone, etc. Additionally, some or all the processing can be performed all on the same device, on one or more other devices that communicates with the device, or various other combinations. The processor may also be incorporated in a network and portions of the process may be performed by separate devices in the network. Processing electronics can be included elsewhere on or external to the laser 10 and may be included, for example, in the valves 27, 29, as well as in or on the gas source 30 or elsewhere. The control electronics 42 may be in the form of processors, chips, circuitry, or other components or devices and may comprise non-electronic components as well. Other types of processing, electronic, optical, or other, can be employed using technology well known in the art as well as technology yet to be developed.

A wide variety of variations are possible. Processing steps may be added or removed, or reordered. Similarly, components may be added, removed, or reordered. Different components may be substituted out. The arrangement and configuration may be different.

While the foregoing detailed description discloses several embodiments of the present invention, it should be understood that this disclosure is illustrative only and is not limiting of the present invention. It should be appreciated that the specific configurations and operations disclosed can differ from those described above, and that the methods described herein can be used in other contexts.

What is claimed is:

1. A method of recharging an excimer laser, the method comprising:
opening an outlet in a chamber containing spent laser gas at a first pressure;
opening an inlet in the chamber, the inlet in communication with a laser gas container at a second pressure higher than the first pressure; and
flowing fresh laser gas into the chamber and removing at least a portion of the spent laser gases from the chamber without using a vacuum pump.

2. The method of claim 1, wherein the outlet is opened prior to opening the inlet or the inlet is opened prior to opening the outlet.

3. The method of claim 1, wherein the inlet and the outlet are opened simultaneously.

4. The method of claim 1, further comprising:
closing the outlet; and
closing the inlet after the chamber is pressurized with the fresh laser gas.

5. The method of claim 1, wherein the first pressure is greater than an ambient pressure.

6. The method of claim 1, wherein the flowing removes a substantial portion of the spent laser gases.

7. The method of claim 1, wherein the flowing removes a majority of the spent laser gases.

8. A method of recharging an excimer laser, the method comprising:
opening an outlet in a chamber containing a first gas at a first pressure;
opening an inlet in the chamber, the inlet in communication with a container containing a second gas at a second pressure higher than the first pressure of the first gas in the chamber; and
flowing the second gas from the container into the chamber and removing the majority of the first gases from the chamber without using a vacuum pump.

9. The method of claim 8, wherein the outlet is opened prior to opening the inlet or the inlet is opened prior to opening the outlet.

10. The method of claim 8, wherein the inlet and the outlet are opened simultaneously.

11. The method of claim 8, further comprising:
closing the outlet; and
closing the inlet after the chamber is pressurized with the fresh laser gas.

12. The method of claim 8, wherein the first gas comprises laser gas.

13. The method of claim 8, wherein the first gas comprises an inert gas.

14. The method of claim 13, wherein the second gas comprises laser gas.

15. A method of recharging an excimer laser, the method comprising:
opening an outlet in a chamber containing spent laser gas at a first pressure;
opening an inlet in the chamber, the inlet in communication with a laser gas container at a second pressure higher than the first pressure; and
flowing fresh laser gas into the chamber and removing at least a portion of the spent laser gases from the chamber with both the inlet and outlet open.

16. The method of claim 15, wherein the flowing removes a substantial portion of the spent laser gases.

17. The method of claim 15, wherein the flowing removes a majority of the spent laser gases.

18. An apparatus for recharging an excimer laser, the apparatus comprising:
a first valve for opening and closing an outlet in a laser chamber containing spent laser gas at a first pressure;
a second valve for an inlet in the chamber, the inlet in fluid communication with a laser gas container at a second pressure higher than the first pressure; and
a controller in communication with the first and second valves, the controller configured to open the first and second valves such that at least a portion of the spent laser gas is removed and fresh laser gas from the laser gas container is introduced without using a vacuum pump.

19. The method of claim 18, wherein the controller comprises a microprocessor.
